(19) United States
(12) Patent Application Publication
(10) Pub. No.: US 2026/0170879 A1
(43) Pub. Date: Jun. 18, 2026

(54) VEHICLE

(71) Applicant: TOYOTA JIDOSHA KABUSHIKI KAISHA, Toyota-shi (JP)

(72) Inventors: Keito Nishikawa, Seto-shi (JP); Masahiro Kagami, Nagoya-shi (JP)

(73) Assignee: TOYOTA JIDOSHA KABUSHIKI KAISHA, Toyota-shi (JP)

(21) Appl. No.: 19/403,450

(22) Filed: Nov. 28, 2025

(30) Foreign Application Priority Data
Dec. 13, 2024 (JP) 2024-218651

(51) Int. Cl. G07C 5/00; B60L 50/60; B60L 58/16; G07C 5/04; H01M 10/42; H01M 10/48

(52) U.S. Cl. CPC G07C 5/004; B60L 50/60; G07C 5/04; H01M 10/425; H01M 10/488; B60L 58/16; H01M 2010/4271; H01M 2220/20

(57) ABSTRACT

A vehicle includes a battery, a display device, and a control device. The control device estimates the degree of degradation of the battery, and controls the display device such that a parameter indicating the estimated degree of degradation of the battery is displayed. When a control program has been rewritten, the control device determines whether first identification information of the control program before rewriting matches second identification information of the control program after rewriting. When the first identification information matches the second identification information, the control device controls the display device such that a first travel distance expressed in a predetermined format is displayed. When the first identification information does not match the second identification information, the control device controls the display device such that a second travel distance is displayed. The first travel distance is a cumulative travel distance that the vehicle has traveled since the parameter was updated.

### CROSS-REFERENCE TO RELATED APPLICATION

This application claims priority to Japanese Patent Application No. 2024-218651 filed on Dec. 13, 2024. The disclosure of the above-identified application, including the specification, drawings, and claims, is incorporated by reference herein in its entirety.

### BACKGROUND

### 1. Technical Field

The present disclosure relates to vehicles.

### 2. Description of Related Art

Japanese Unexamined Patent Application Publication No. 2003-164006 (JP 2003-164006 A) discloses a display device that displays the capacity of a vehicle battery. This display device includes a plurality of segments (first display means) that stepwise display the remaining battery level (stored energy), which changes over time with power consumption, and an Empty indicator lamp (second display means) that turns on when the remaining battery level falls below a threshold. The threshold for turning on the Empty indicator lamp varies depending on the degree of battery degradation in the vehicle.

### SUMMARY

The display device disclosed in JP 2003-164006 A estimates the degree of battery degradation and determines the threshold for turning on the Empty indicator lamp based on the estimated degree of battery degradation. However, it is not always possible to obtain an accurate degree of battery deterioration. If a notification process is executed based on an unreliable degree of battery degradation, it may actually reduce user convenience. For example, if the Empty indicator lamp turns on even though there is still sufficient stored energy (remaining battery level), it may become difficult for the user to accurately grasp the state of the vehicle.

The present disclosure has been made to solve the above issue, and an object thereof is to improve user convenience by appropriately displaying a parameter indicating the state of the vehicle.

One aspect of the present disclosure provides a vehicle. The vehicle includes a battery, a display device, and a control device. The control device includes a storage device configured to store a control program related to the battery, and a processor configured to execute the control program. The control device is configured to estimate a degree of degradation of the battery, and to control the display device such that a parameter indicating the estimated degree of degradation of the battery is displayed. The control device is configured to, when the control program has been rewritten, determine whether first identification information of the control program before rewriting matches second identification information of the control program after the rewriting. The control device is configured to, when the first identification information matches the second identification information, control the display device such that a first travel distance expressed in a predetermined format is displayed. The control device is configured to, when the first identification information does not match the second identification information, control the display device such that a second travel distance is displayed. The first travel distance is a cumulative travel distance that the vehicle has traveled since the parameter was updated. The second travel distance is a maximum value in the predetermined format.

The present disclosure makes it possible to improve user convenience by appropriately displaying a parameter indicating the state of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a vehicle according to an embodiment of the present disclosure;

FIG. 2 is a flowchart showing a state-of-health (SOH) update process according to the embodiment of the present disclosure;

FIG. 3 is a flowchart showing display control according to the embodiment of the present disclosure;

FIG. 4 is a diagram illustrating an example of program rewriting; and

FIG. 5 is a diagram showing an example of the operation of a display device in accordance with the display control shown in FIG. 3.

### DETAILED DESCRIPTION OF EMBODIMENTS

An embodiment of the present disclosure will be described in detail with reference to the drawings. The same or corresponding portions are denoted by the same signs throughout the drawings, and description thereof will not be repeated.

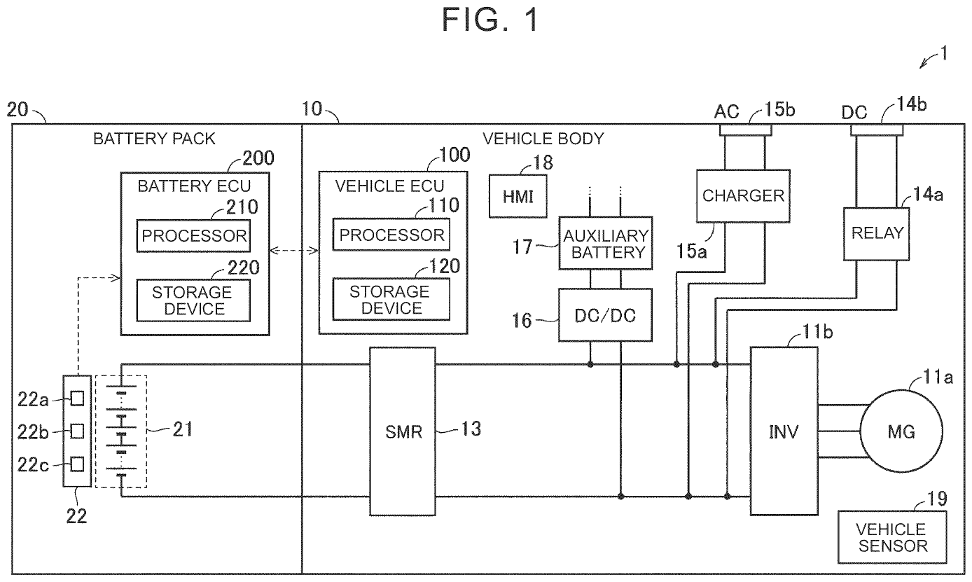

FIG. 1 is a diagram showing the configuration of a vehicle according to the present embodiment. Referring to FIG. 1, a vehicle 1 includes a vehicle body 10 and a battery pack 20. The vehicle body 10 refers to the portion of the vehicle 1 excluding the battery pack 20. The battery pack 20 is an example of the “energy storage device” according to the present disclosure.

The vehicle body 10 includes a motor generator (MG) 11a, an inverter 11b, a system main relay (SMR) 13, a direct current (DC) charging relay 14a, a DC inlet 14b, an alternating current (AC) charger 15a, an AC inlet 15b, a DC/DC converter 16, an auxiliary battery 17, a human-machine interface (HMI) 18, a vehicle sensor 19, and a vehicle ECU 100. The battery pack 20 houses a battery 21, a monitoring unit 22, and a battery ECU 200. The term “ECU” stands for electronic control unit. The battery ECU 200 is an example of the “control device” according to the present disclosure. The vehicle 1 is configured to travel using power output from the battery 21. The vehicle 1 is, for example, a battery electric vehicle (BEV) that is not equipped with an internal combustion engine. However, the vehicle 1 is not limited to the BEV, and may be a plug-in hybrid electric vehicle (PHEV) equipped with an internal combustion engine, or another type of electrified vehicle (xEV).

The vehicle ECU 100 includes a processor 110 and a storage device 120. The battery ECU 200 includes a processor 210 and a storage device 220. Each storage device is configured to save stored information. In addition to programs, each storage device stores various types of information used by the programs. In each ECU, the processor executes programs stored in the storage device to perform various control operations.

The vehicle ECU 100 and the battery ECU 200 are configured to communicate with each other. The vehicle ECU 100 is configured to receive detection signals from various sensors included in the vehicle sensor 19 and control various devices installed in the vehicle body 10. In the present embodiment, the vehicle sensor 19 includes a travel distance meter (e.g., an odometer). The battery ECU 200 is configured to monitor the state of the battery 21 and send control commands related to the battery 21 to the vehicle ECU 100. The battery ECU 200 can control various devices installed in the vehicle body 10 via the vehicle ECU 100. The vehicle ECU 100 controls the inverter 11b, the SMR 13, the DC charging relay 14a, the AC charger 15a, the DC/DC converter 16, and the HMI 18, which will be described later, either in response to requests from the battery ECU 200 or on its own initiative.

The MG 11a serves as a traction motor. The inverter 11b serves as a power control unit (PCU) for the MG 11a. The inverter 11 b drives the MG 11 a using power supplied from the battery 21. The MG 11a converts electric power into torque to rotate the drive wheels of the vehicle 1. Additionally, the MG 11a performs regenerative power generation during, for example, deceleration of the vehicle 1 and charges the battery 21. The SMR 13 selectively connects or disconnects the electrical path between the battery 21 and the inverter 11b.

The DC inlet 14b and the AC inlet 15b are configured to allow connection with a DC charging cable and an AC charging cable, respectively. Each of the DC inlet 14b and the AC inlet 15b has a terminal for detecting whether a charging cable (charging plug) is connected or disconnected, and outputs, to the vehicle ECU 100, a signal indicating whether the charging cable is connected. When the battery 21 is charged with direct current power input from outside the vehicle via the DC inlet 14b, the vehicle ECU 100 brings the SMR 13 and the DC charging relay 14a into a closed (connected) state. The AC charger 15a performs AC/DC conversion. When the battery 21 is charged with alternating current power input from outside the vehicle via the AC inlet 15b, the vehicle ECU 100 controls the AC charger 15a with the SMR 13 being in a closed state (connected state) and alternating current power being input from outside the vehicle to the AC charger 15a via the AC inlet 15b. The AC charger 15a converts the alternating current power into direct current power in accordance with a control command from the vehicle ECU 100 and outputs the direct current power to the battery 21. The vehicle 1 is configured to perform external charging (charging of the battery 21 using power supplied from outside the vehicle) via the DC inlet 14b or the AC inlet 15b while parked. The vehicle 1 may also be configured to perform external power supply (power supply performed by outputting power from the battery 21 to an external device) via the DC inlet 14b or the AC inlet 15b while parked.

The DC/DC converter 16 performs voltage conversion of direct current power. For example, the DC/DC converter 16 steps down direct current power from the battery 21 and outputs it to the auxiliary battery 17. The auxiliary battery 17 supplies power for driving auxiliary devices installed in the vehicle 1. The auxiliary battery 17 outputs electric power at a voltage lower than the voltage of the battery 21. The capacity of the battery 21 is greater than that of the auxiliary battery 17. The vehicle ECU 100 may control the DC/DC converter 16 such that, when the remaining stored energy of the auxiliary battery 17 becomes low, electric power is supplied from the battery 21 to the auxiliary battery 17. The auxiliary battery 17 may supply electric power to the battery pack 20. The battery ECU 200 may receive electric power from the auxiliary battery 17.

The HMI 18 includes an input device and a display device. The HMI 18 may include a touch panel display. The input device outputs a signal to the vehicle ECU 100 in response to user input. In the present embodiment, the HMI 18 includes a start switch of the vehicle 1. The start switch is commonly referred to as “power switch” or “ignition switch.” The display device is controlled by the vehicle ECU 100.

The battery 21 is a secondary battery such as a lithium-ion battery, a nickel metal hydride battery, or a sodium-ion battery. The secondary battery may be either a liquid secondary battery or an all-solid-state secondary battery. A plurality of secondary batteries may form a battery pack. The monitoring unit 22 includes a voltage sensor 22a that detects the voltage of the battery 21, a current sensor 22b that detects the current of the battery 21, and a temperature sensor 22c that detects the temperature of the battery 21. Detection results from the sensors included in the monitoring unit 22 are output to the battery ECU 200. The monitoring unit 22 and the battery ECU 200 may serve as a battery management system (BMS). The battery ECU 200 is configured to acquire the state of charge (SOC) of the battery 21 using the sensor detection values output from the monitoring unit 22. The SOC indicates the charge level, and is expressed, for example, as a percentage in the range of 0% to 100%, representing the ratio of the current amount of stored energy to the amount of stored energy when fully charged.

The storage device 220 of the battery ECU 200 stores the state of health (SOH) of the battery 21 and the post-SOH-update distance. The SOH of the battery 21 is a parameter that indicates the degree of degradation of the battery 21. In the present embodiment, the capacity retention rate is adopted as the SOH. The capacity retention rate represents the percentage of the current capacity relative to the initial capacity. The greater the degree of degradation of the battery 21, the lower the capacity retention rate of the battery 21 becomes. The storage device 220 stores the estimated value and the display value of the SOH of the battery 21 separately (hereinafter also referred to as “estimated SOH value” and “SOH display value,” respectively). Initially, both the estimated value and the display value of the SOH (capacity retention rate) are set to 100%. The estimated SOH value indicates the gross value of the estimated SOH. On the other hand, the SOH display value indicates the net value of the SOH displayed on the display device. The gross value and the net value will be described in detail later. The post-SOH-update distance indicates the cumulative travel distance that the vehicle 1 has traveled since the SOH display value was updated. In other words, the post-SOH-update distance indicates the cumulative distance that the vehicle 1 has traveled without the SOH display value being updated.

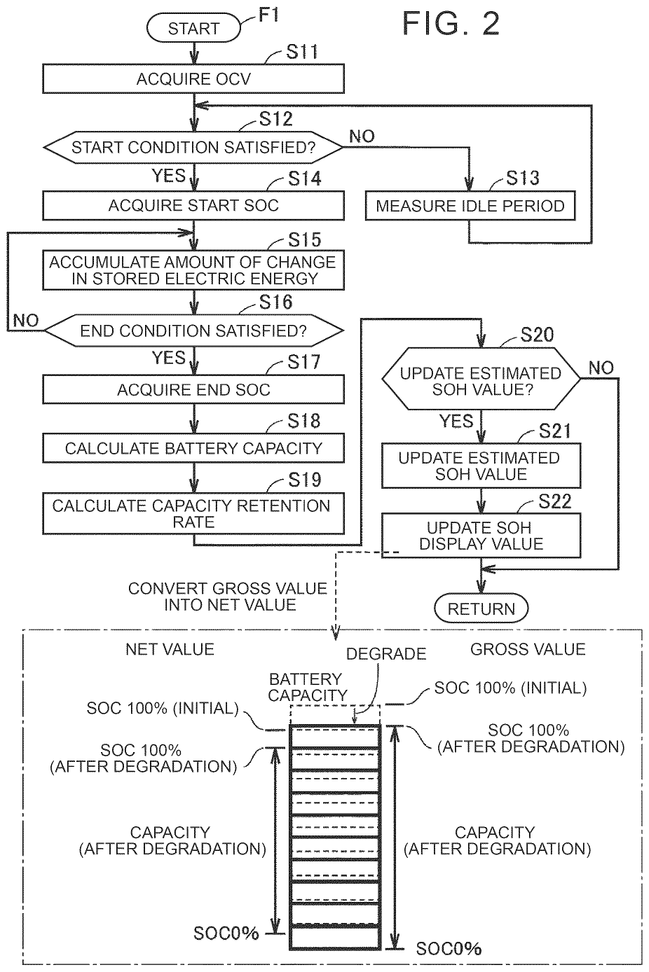

FIG. 2 is a flowchart illustrating an SOH update process executed by the battery ECU 200. The processing flow F1 shown in FIG. 2 is repeatedly executed by the battery ECU 200. The letter “S” in the flowchart indicates a step.

Referring to FIG. 2, in the processing flow F1, the battery ECU 200 acquires, in S11, the open circuit voltage (OCV) of the battery 21 using the voltage sensor 22a. In S12, the battery ECU 200 then determines whether a predetermined condition (hereinafter referred to as “start condition”) is satisfied. When the start condition is not satisfied (NO in S12), the battery ECU 200 measures, in S13, the time until the start condition becomes satisfied. The time measured in S13 represents the duration of a vehicle idle period (i.e., a period during which none of traveling, external charging, or external power supply occurs). While the start condition is not satisfied, S12 and S13 are repeated at a predetermined computation cycle.

In the present embodiment, the start condition is satisfied when the absolute value of the amount of change in stored electric energy per unit time is greater than or equal to a predetermined value (hereinafter referred to as “first threshold”). The amount of change in stored electric energy indicates the magnitude of change in the amount of electric energy stored in the battery 21. For example, the amount of change in stored electric energy during charging is expressed as a positive value, while the amount of change in stored electric energy during discharging is expressed as a negative value. Specifically, in S12, the battery ECU 200 acquires the current value of the battery 21 using the current sensor 22b, and stores the acquired current value in the storage device 220 in association with its acquisition time. The battery ECU 200 then calculates the amount of change in stored electric energy per unit time of the battery 21. The unit time is, for example, the above-mentioned computation cycle. When the absolute value of the calculated amount of change in stored electric energy is greater than or equal to the first threshold, the battery ECU 200 determines that the start condition is satisfied. When external charging is started in the vehicle 1, the amount of change in stored electric energy increases in the positive direction, and the absolute value of the amount of change in stored electric energy per unit time exceeds the first threshold. When the vehicle 1 starts traveling using power from the battery 21, the amount of change in stored electric energy increases in the negative direction, and the absolute value of the amount of change in stored electric energy per unit time exceeds the first threshold.

When the start condition is satisfied (YES in S12), the battery ECU 200 acquires the SOC (hereinafter referred to as “start SOC”) of the battery 21 in S14. The start SOC corresponds to the SOC (gross value) of the battery 21 at the time the start condition is satisfied. For example, the storage device 220 stores in advance a map (OCV-SOC curve) that represents the relationship between the OCV and the SOC (gross value) of the battery 21 in its initial (non-degraded) state. The battery ECU 200 may refer to this map to acquire the SOC (gross value) of the battery 21 from the OCV of the battery 21 acquired in S11. The battery ECU 200 may set the acquired SOC of the battery 21 as the start SOC. Alternatively, the battery ECU 200 may correct the acquired SOC of the battery 21 by using at least one of the following values and set the corrected SOC as the start SOC: the current value (amount of change in stored electric energy) of the battery 21 acquired in S12, the time (vehicle idle period) measured in S13, and the temperature of the battery 21 acquired via the temperature sensor 22c.

Subsequently, the battery ECU 200 accumulates the amount of change in stored electric energy in S15. The battery ECU 200 then determines in S16 whether a predetermined condition (hereinafter referred to as “end condition”) is satisfied. When the end condition is not satisfied (NO in S16), the process returns to S15. While the end condition is not satisfied, the processing in S15 and S16 is repeatedly executed at the above-mentioned computation cycle.

In the present embodiment, the end condition is satisfied when the absolute value of the amount of change in stored electric energy per unit time falls below a predetermined value (hereinafter referred to as “second threshold”). The second threshold is a value less than or equal to the first threshold. The unit time is, for example, the above-mentioned computation cycle. Specifically, in S15, the battery ECU 200 acquires the current value of the battery 21 using the current sensor 22b and stores the acquired current value in the storage device 220 in association with its acquisition time. The battery ECU 200 then calculates the amount of change in stored electric energy per unit time of the battery 21 and accumulates the amount of change in stored electric energy using the calculated amount of change in stored electric energy per unit time. During the period from when the start condition is satisfied until the end condition is satisfied (hereinafter referred to as “target period”), S15 is repeated. The amount of change in stored electric energy during the target period is thus obtained. The end condition is satisfied when the absolute value of the amount of change in stored electric energy per unit time falls below the second threshold. For example, when external charging that has been performed in the vehicle 1 is stopped, the absolute value of the amount of change in stored electric energy per unit time falls below the second threshold. Similarly, when the vehicle 1 that has been traveling comes to a stop, the absolute value of the amount of change in stored electric energy per unit time also falls below the second threshold.

When the end condition is satisfied (YES in S16), the battery ECU 200 acquires the OCV of the battery 21 using the voltage sensor 22a and acquires the SOC of the battery 21 (hereinafter referred to as “end SOC”) using the acquired OCV, in S17. The end SOC corresponds to the SOC (gross value) of the battery 21 at the time the end condition is satisfied. The battery ECU 200 refers to, for example, the above-mentioned map (OCV-SOC curve) to acquire the SOC (gross value) of the battery 21 from the OCV of the battery 21. The battery ECU 200 may set the acquired SOC of the battery 21 as the end SOC. Alternatively, the battery ECU 200 may correct the acquired SOC of the battery 21 using the temperature of the battery 21, and set the corrected SOC as the end SOC.

In S18, the battery ECU 200 calculates the capacity C1 of the battery 21 according to the following Equation (1). The capacity C1 corresponds to the amount of electric energy stored in the battery 21 when fully charged.

$$C 1 = 100 \times dST / \vert SOC 1 - SOC 2 \vert \qquad ( 1 )$$

In Equation (1), SOC1 represents the start SOC, SOC2 represents the end SOC, and dST represents the amount of change in stored electric energy during the target period. The term |SOC1−SOC2| corresponds to the difference (absolute value) between the start SOC and the end SOC. For example, when the SOC of the battery 21 increases from 10% to 60% during external charging in the target period, and the amount of charged energy (i.e., the amount of energy input to the battery 21 during external charging) is 25 kWh, the calculated capacity C1 of the battery 21 according to Equation (1) is 50 kWh (32 100×25/50). The battery ECU 200 stores the calculated capacity C1 in the storage device 220 in association with its acquisition time.

Thereafter, in S19, the battery ECU 200 calculates the capacity retention rate (SOH) of the battery 21 according to the following Equation (2).

$$SOH = 100 \times C 1 / C 0 \qquad ( 2 )$$

In Equation (2), C0 represents the capacity (gross value) of the battery 21 in its initial (non-degraded) state. C0 is stored in advance in, for example, the storage device 220. As described above, the battery ECU 200 acquires the capacity retention rate of the battery 21 by dividing C1 calculated in S18 by C0. The battery ECU 200 stores the calculated capacity retention rate (SOH) in the storage device 220 in association with its acquisition time.

Subsequently, the battery ECU 200 determines in S20 whether to update the estimated SOH value. For example, the battery ECU 200 determines to update the estimated SOH value when |SOC1−SOC2| is greater than or equal to a first reference value, and determines not to update the estimated SOH value when |SOC1−SOC2| is less than the first reference value. The value of |SOC1−SOC2| being greater than or equal to the first reference value indicates that the SOH has been estimated with sufficiently high accuracy.

When it is determined that the estimated SOH value should be updated (YES in S20), the battery ECU 200 updates the estimated SOH value stored in the storage device 220 in S21. Specifically, the battery ECU 200 may determine the latest estimated SOH value (gross value) using the capacity C1 calculated in the current processing routine (S18), the capacity C1 calculated in a previous processing routine (S18), the first reference value, and a second reference value. The second reference value is greater than the first reference value. For example, in the present processing routine, when |SOC1−SOC2| is greater than or equal to the second reference value, the battery ECU 200 sets the capacity retention rate calculated in the current processing routine (S19) as the latest estimated SOH value. In this case, the capacity C1 calculated in the current processing routine (S18) corresponds to the estimated value of the capacity of the battery 21. On the other hand, when |SOC1−SOC2| in the current processing routine is greater than or equal to the first reference value and less than the second reference value, the battery ECU 200 uses, as the estimated value of the capacity of the battery 21, the average value of a predetermined number (e.g., 2 to 10) of most recent pieces of data among the data on the capacity C1 calculated in the current or past processing routines (S18) (excluding data where |SOC1−SOC2| is less than the first reference value). The battery ECU 200 then substitutes the obtained estimated value of the capacity of the battery 21 for C1 in Equation (2) to calculate SOH, and sets the obtained SOH value as the latest estimated SOH value.

Next, in S22, the battery ECU 200 updates the SOH display value stored in the storage device 220. Specifically, the battery ECU 200 converts the updated estimated SOH value (gross value) into a net value. The gross values that indicate the characteristics of the battery 21 (e.g., capacity, SOC, and capacity retention rate) are numerical values indicating the characteristics of the battery 21 alone. The net values that indicate the characteristics of the battery 21 are numerical values indicating the characteristics of the battery 21 in a state in which the battery 21 is mounted in the vehicle 1. In the present embodiment, the battery ECU 200 limits the usable SOC range (operational range) of the battery 21 based on a lower SOC limit and an upper SOC limit defined in the control program. The battery ECU 200 is configured to control the SOC of the battery 21 within the range from the lower SOC limit to the upper SOC limit. For example, the lower SOC limit and the upper SOC limit may be set to suppress degradation of the battery 21. These values are set using the scale of the gross value. Therefore, when the scale of the gross value changes due to battery degradation, the lower SOC limit and the upper SOC limit also change. For example, the lower SOC limit and the upper SOC limit may correspond to 10% and 90%, respectively, on the gross scale. However, the net value of the SOC is expressed such that the lower SOC limit and the upper SOC limit correspond to 0% and 100%, respectively. The net value of the capacity of the battery 21 corresponds to the amount of electric energy input to the battery 21 when the SOC of the battery 21 is increased from the lower SOC limit to the upper SOC limit. Accordingly, the net value of the capacity of the battery 21 is smaller than the gross value of the capacity of the battery 21. The battery ECU 200 converts the estimated value (gross value) of the capacity of the battery 21 obtained in S21 into a net value, based on the lower SOC limit and the upper SOC limit. The estimated value (net value) of the capacity of the battery 21 thus obtained corresponds to the estimated value of the capacity of the battery 21 from the lower SOC limit to the upper SOC limit. The battery ECU 200 also converts the capacity (gross value) of the battery 21 in the initial state into a net value, based on the lower SOC limit and the upper SOC limit. The battery ECU 200 substitutes the estimated value (net value) of the capacity of the battery 21 and the capacity (net value) of the battery 21 in the initial state for C1 and C0 in Equation (2), respectively, to calculate SOH. The SOH value (capacity retention rate) thus calculated corresponds to the net value of the estimated SOH value. In S22, the battery ECU 200 sets the estimated SOH value (net value) obtained as described above as the SOH display value. Once the processing in S22 is completed, the process returns to the initial step (S11).

When |SOC1−SOC2| is less than the first reference value in the current processing routine (NO in S20), the estimated SOH value stored in the storage device 220 remains unchanged. In this case, S21 and S22 are skipped, and the process returns to the initial step (S11). Therefore, the SOH display value is not updated.

In the processing flow F1 shown in FIG. 2, the start and end conditions described above may be changed as appropriate. For example, the start condition may be satisfied when external charging is started in the vehicle 1. In a configuration where the vehicle 1 is capable of external power supply, the start condition may be satisfied when external power supply is started in the vehicle 1. The end condition may be satisfied when either external charging or external power supply is stopped in the vehicle 1.

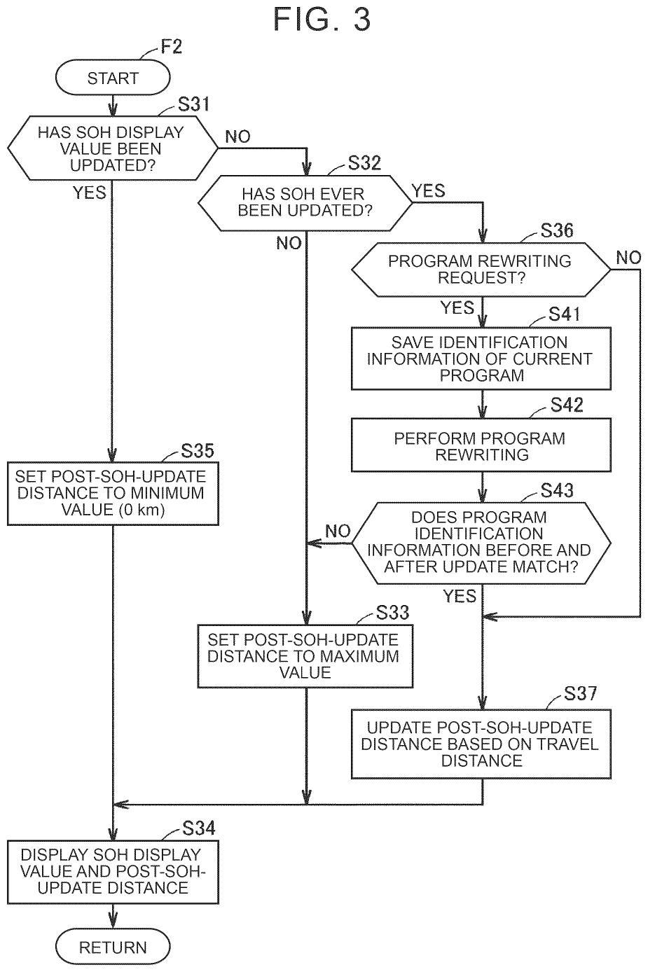

FIG. 3 is a flowchart showing display control performed by the battery ECU 200. The processing flow F2 shown in FIG. 3 is repeatedly executed by the battery ECU 200. The processing flow F2 is executed in parallel with the processing flow F1 shown in FIG. 2.

Referring to FIG. 3, in the processing flow F2, the battery ECU 200 determines in S31 whether the SOH display value has been updated. When the SOH display value has been updated by the processing in S22 of FIG. 2, the determination in S31 is YES, and the process proceeds to S35. When the SOH display value has not been updated, the determination in S31 is NO, and the process proceeds to S32. In S32, the battery ECU 200 determines whether the SOH display value has ever been updated in the past. When the SOH display value has never been updated since the vehicle 1 was shipped, the determination in S32 is NO, and the process proceeds to S33. In this case, the SOH display value remains at its initial value (100%). In S33, the battery ECU 200 sets the post-SOH-update distance to the maximum value. In the present embodiment, the post-SOH-update distance is expressed as a 16-bit binary value. Therefore, the maximum value of the post-SOH-update distance is 65535 km. Thereafter, in S34, the battery ECU 200 controls the display device of the HMI 18 such that the SOH display value and the post-SOH-update distance are displayed. As a result of the processing in S34, the display device displays the initial SOH display value (100%) and the maximum value of the post-SOH-update distance (65535 km). Once the processing in S34 is completed, the process returns to the initial step (S31).

When the SOH display value has been updated by the processing in S22 of FIG. 2 (YES in S31), the battery ECU 200 sets the post-SOH-update distance to the minimum value (0 km) in S35. The process then proceeds to S34. As a result of the processing in S34, the display device displays the updated SOH display value and the minimum value of the post-SOH-update distance (0 km). Since the SOH display value has been updated, the determination in S32 will subsequently be YES.

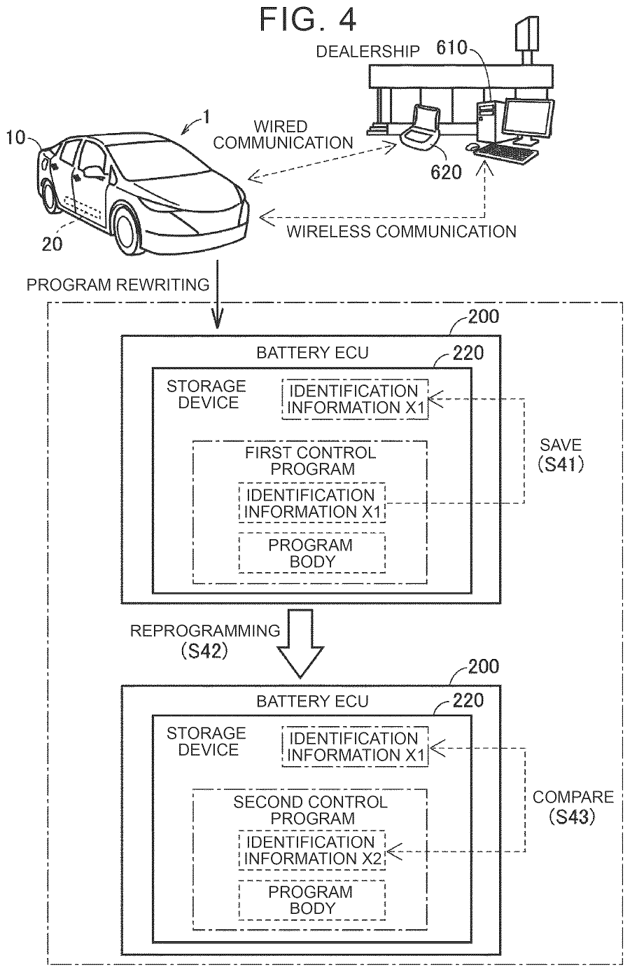

When YES in S32, the battery ECU 200 determines in S36 whether a program rewriting request has been received. The program rewriting request will be described later (see FIG. 4). When the battery ECU 200 has not received a program rewriting request (NO in S36), the process proceeds to S37. In S37, the battery ECU 200 updates the post-SOH-update distance stored in the storage device 220. Specifically, the battery ECU 200 acquires the measurement value from the travel distance meter via the vehicle ECU 100, and accumulates the distance that the vehicle 1 has traveled since the post-SOH-update distance was set to 0 km in S35. The battery ECU 200 then sets the obtained accumulated value as the post-SOH-update distance. Thereafter, the process proceeds to S34. As a result of the processing in S34, the display device displays the current SOH display value and the updated post-SOH-update distance. Thereafter, as long as the determination in S31 is NO, the determination in S32 is YES, and the determination in S36 is NO, the post-SOH-update distance is repeatedly updated in S37.

When the battery ECU 200 has received a program rewriting request (YES in S36), the process proceeds to S41. The processing from S41 onward will now be described with reference to FIGS. 3 and 4. FIG. 4 is a diagram illustrating an example of program rewriting.

In FIG. 4, the dealership includes a server 610 configured to communicate wirelessly with the vehicle 1, and a scan tool 620 configured to communicate with the vehicle 1 via a wired connection. The scan tool 620 is an external diagnostic device used by a service provider (e.g., a mechanic) to check the state of the vehicle 1. The service provider or the vehicle user can send a program rewriting request to the battery ECU 200 via an external terminal or an in-vehicle terminal. In the present embodiment, each of the server 610 and the scan tool 620 serves as an external terminal. The vehicle ECU 100 and the HMI 18 serve as in-vehicle terminals.

When the in-vehicle terminal receives a reprogramming notification from the server 610 while the vehicle 1 is parked, the HMI 18 prompts the user to input whether to consent to the reprogramming. When the HMI 18 receives, from the user, an input indicating consent, the vehicle ECU 100 requests the battery ECU 200 to perform reprogramming. When the scan tool 620 that holds a new (updated) control program is connected to the battery ECU 200 of the parked vehicle 1, the scan tool 620 requests the battery ECU 200 to perform reprogramming. These reprogramming requests correspond to program rewrite requests.

Before program rewriting, the storage device 220 stores a first control program identified by identification information X1. The first control program includes the identification information X1 and a program body. The program body includes a control algorithm and various parameters. The control algorithm may include an algorithm for either or both of charging control and discharging control of the battery 21. The control algorithm may also include an algorithm for the management of the state of the battery 21 (such as estimation of the degree of degradation and degradation suppression).

When the battery ECU 200 receives a reprogramming request, it saves the identification information of the control program before rewriting in S41 of FIG. 3. Specifically, as shown in FIG. 4, the battery ECU 200 stores the identification information X1 in a region of the storage device 220 other than the region in which the control program is written. Then, in S42 of FIG. 3, the battery ECU 200 performs the requested program rewriting (reprogramming). As a result of the reprogramming, the first control program stored in the storage device 220 is erased, and a second control program identified by identification information X2 is written to the storage device 220. The second control program is written to the storage device 220 with the identification information X2 linked to the program body. Each of the identification information X1 and the identification information X2 is unique information assigned to each control program. Each of the identification information X1 and the identification information X2 may be a program ID (e.g., a program product number). Each of the first and second control programs is a control program related to the battery 21, and is executed by the processor 210. However, the content of the program body differs between the first and second control programs. For example, functions (controls) may be added or modified by updating the control algorithm through reprogramming.

Thereafter, in S43 of FIG. 3, the battery ECU 200 determines whether first identification information of the control program before rewriting saved in S41 matches second identification information of the control program after rewriting. When the reprogramming is executed, the identification information and the program body of the control program stored in the storage device 220 are changed. Therefore, when the reprogramming has been executed, the determination in S43 of FIG. 3 is NO, and the process proceeds to S33. In this case, the post-SOH-update distance is set to the maximum value in S33, and thereafter, the current SOH display value and the maximum value of the post-SOH-update distance (65535 km) are displayed in S34.

Referring again to FIG. 3, when the program rewriting performed in S43 is rewriting without a change in identification information, the determination in S43 is YES, and the process proceeds to S37. In this case, the post-SOH-update distance is updated in S37, and thereafter, the current SOH display value and the updated post-SOH-update distance are displayed in S34. An example of program rewriting without a change in identification information is initialization of various parameters that can be set by the user. The lower and upper SOC limits described above are parameters that cannot be set (changed) by the user.

The battery ECU 200 estimates the degree of degradation of the battery 21, and controls the display device (HMI 18) such that a parameter (SOH display value) indicating the estimated degree of degradation of the battery 21 is displayed. The battery ECU 200 updates the parameter each time a predetermined condition (hereinafter, referred to as “update condition”) is satisfied. In the present embodiment, the processing in S14 to S19 of FIG. 2 corresponds to the process of estimating the degree of degradation of the battery 21. The processing in S34 of FIG. 3 corresponds to the process of displaying the parameter indicating the estimated degree of degradation of the battery 21. The processing in S21 and S22 of FIG. 2 corresponds to the process of updating the parameter. In the present embodiment, the update condition is satisfied when the determination in S20 of FIG. 2 is YES after the degree of degradation of the battery 21 is estimated through the processing in S14 to S19 of FIG. 2.

The battery ECU 200 is configured to cause the display device to display a travel distance selected from among a first travel distance expressed in a predetermined format, a second travel distance that is a maximum value in the predetermined format, and a third travel distance that is a minimum value in the predetermined format. The first travel distance is the cumulative travel distance that the vehicle 1 has traveled since the parameter was updated. The first travel distance is set to the post-SOH-update distance in S37 of FIG. 3, and is displayed in S34 of FIG. 3. The second travel distance is set to the post-SOH-update distance in S33 of FIG. 3, and is displayed in S34 of FIG. 3. The third travel distance is set to the post-SOH-update distance in S35 of FIG. 3, and is displayed in S34 of FIG. 3.

When the control program stored in the storage device 220 has been rewritten, the battery ECU 200 determines whether the first identification information of the control program before rewriting matches the second identification information of the control program after rewriting (S43 in FIG. 3). When the first identification information matches the second identification information, the battery ECU 200 controls the display device such that the first travel distance expressed in the predetermined format is displayed (S37 and S34 in FIG. 3). On the other hand, when the first identification information does not match the second identification information, the battery ECU 200 controls the display device such that the second travel distance is displayed (S33 and S34 in FIG. 3).

The battery 21 tends to degrade as the cumulative travel distance of the vehicle 1 increases. Therefore, the reliability of the SOH display value continuously decreases as the first travel distance increases. The battery ECU 200 can notify the user of the reliability in accordance with the travel distance by displaying the first travel distance together with the SOH display value on the display device. When rewriting of the control program involving a change in the identification information (e.g., reprogramming) is performed, the reliability of the SOH display value decreases regardless of the cumulative travel distance. For example, rewriting of the control program may change the lower and upper SOC limits described above. Rewriting of the control program may also change the method for estimating the degree of degradation of the battery 21. Therefore, when rewriting of the control program involving a change in the identification information is performed, the battery ECU 200 causes the display device to display the second travel distance (the maximum displayable travel distance). This serves to warn the user that the SOH display value should not be trusted. As described above, the user convenience can be improved by appropriately displaying parameters indicating the state of the vehicle 1 (the SOH display value and the post-SOH-update distance). Adopting a 16-bit binary format as the display format for the travel distance makes it easier for the user to recognize that something is wrong. In the 16-bit binary format, the minimum value (third travel distance) is 0 km and the maximum value (second travel distance) is 65535 km. The first travel distance varies within the range of 0 km to 65535 km.

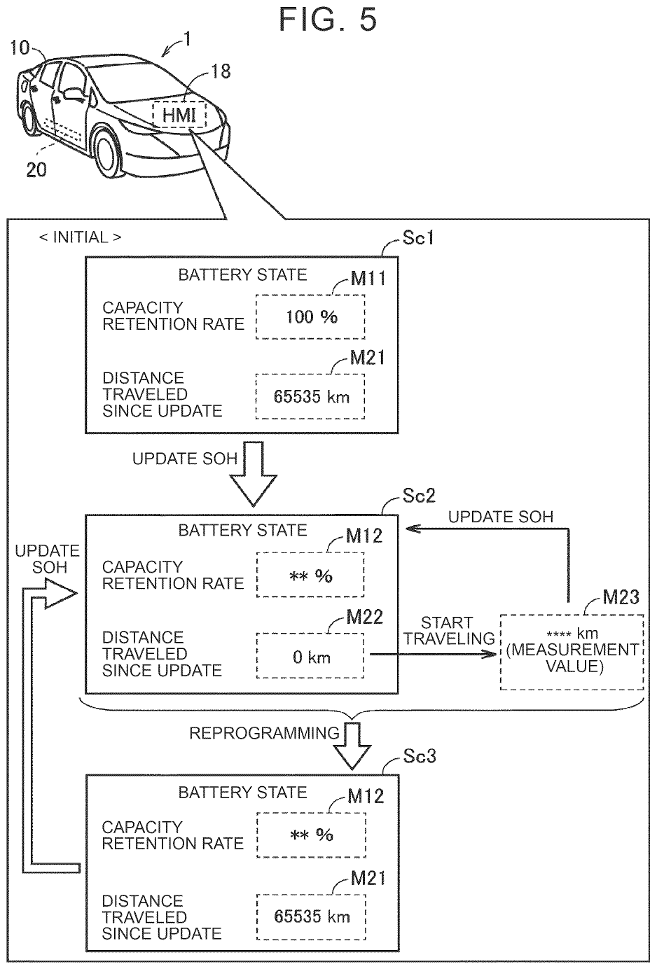

FIG. 5 is a diagram showing an example of the operation of the display device (HMI 18) in accordance with the display control shown in FIG. 3. Referring to FIG. 5 together with FIG. 3, the battery ECU 200 is configured to control the display device of the HMI 18 such that any one of the first travel distance, the second travel distance, and the third travel distance, and the SOH display value are displayed on the same screen. Specifically, initially, the determination in S32 is NO, and the processing in S33 and S34 is executed. As a result, the display device displays, for example, a screen Sc1. The screen Sc1 includes the initial SOH display value M11 and the second travel distance M21. When the SOH display value is updated thereafter, the determination in S31 becomes YES, and the processing in S35 and S34 is executed. As a result, the display device displays, for example, a screen Sc2. The screen Sc2 includes the updated current SOH display value M12 and the third travel distance M22. The third travel distance M22 indicates that the displayed current SOH display value M12 is reliable. Displaying the third travel distance M22 upon update of the SOH display value makes it easier for the user to accurately grasp the degree of degradation of the battery 21. When the vehicle 1 starts traveling thereafter, the processing in S37 and S34 is executed. As a result, the first travel distance M23 is displayed on the screen Sc2 instead of the third travel distance M22.

In the present embodiment, rewriting of the control program involving a change in the identification information (for example, the reprogramming described above) is performed when the vehicle 1 is not traveling. Therefore, during travel of the vehicle 1, the post-SOH-update distance is sequentially updated in S37, and the first travel distance M23 on the screen Sc2 is also sequentially updated. However, when the post-SOH-update distance reaches the maximum value (65535 km), the post-SOH-update distance no longer increases and is maintained at the maximum value. When the SOH display value is updated, the screen Sc2 including the updated current SOH display value M12 and the third travel distance M22 is displayed again.

When rewriting of the control program involving a change in the identification information is performed in the battery ECU 200, the processing of S33 and S34 is executed. As a result, the display device displays, for example, a screen Sc3. The screen Sc3 includes the current SOH display value M12 and the second travel distance M21. Thereafter, when the SOH display value is updated, the display device displays again the screen Sc2 including the updated current SOH display value M12 and the third travel distance M22.

The parameter indicating the degree of degradation of the battery 21 is not limited to the net value of the capacity retention rate. For example, the battery ECU 200 may directly set the gross value of the capacity retention rate estimated in S19 of FIG. 2 as the SOH display value. Alternatively, the display device (HMI 18) may display the estimated capacity (C1) of the battery 21 after degradation and the capacity (C0) of the battery 21 in the initial state on the same screen. The internal resistance value of the battery 21 may be used instead of the capacity retention rate.

The configurations of the vehicle body and the battery pack shown in FIG. 1 may be modified as appropriate. In the above embodiment, the battery ECU 200 indirectly controls the HMI 18 (display device) via the vehicle ECU 100. However, the present disclosure is not limited to this, and the battery ECU 200 may be configured to directly control the HMI 18 (display device). Alternatively, the functions of the battery ECU 200 may be implemented in the vehicle ECU 100. The vehicle ECU 100 may estimate the degree of degradation of the battery 21 based on information acquired from the battery ECU 200. The vehicle is not limited to a passenger car and may be a bus, a truck, or a work vehicle (such as a tractor or a forklift).

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. A vehicle comprising:
a battery;
a display device; and
a control device, wherein:
the control device includes a storage device configured to store a control program related to the battery, and a processor configured to execute the control program;
the control device is configured to estimate a degree of degradation of the battery, and to control the display device such that a parameter indicating the estimated degree of degradation of the battery is displayed;
the control device is configured to
when the control program has been rewritten, determine whether first identification information of the control program before rewriting matches second identification information of the control program after the rewriting,
when the first identification information matches the second identification information, control the display device such that a first travel distance expressed in a predetermined format is displayed, and
when the first identification information does not match the second identification information, control the display device such that a second travel distance is displayed;
the first travel distance is a cumulative travel distance that the vehicle has traveled since the parameter was updated; and
the second travel distance is a maximum value in the predetermined format.

2. The vehicle according to claim 1, wherein:
the control device is configured to update the parameter each time a predetermined condition is satisfied;
the control device is configured to, when the parameter has been updated, control the display device such that a third travel distance is displayed; and
the third travel distance is a minimum value in the predetermined format.

3. The vehicle according to claim 2, wherein:
the control device is configured to control the display device such that any one of the first travel distance, the second travel distance, and the third travel distance, and the parameter are displayed on the same screen; and
the control device is configured to update the parameter on the screen based on a latest estimated value of the degree of degradation.

4. The vehicle according to claim 1, wherein:
the vehicle is configured to travel using electric power output from the battery;
the predetermined format is a 16-bit binary format; and
the second travel distance is 65535 km.

5. The vehicle according to claim 1, further comprising an energy storage device that includes the battery and the control device, wherein:
the parameter is a capacity retention rate;
the control device is configured to control a state of charge of the battery within a range from a lower state-of-charge limit to an upper state-of-charge limit; and
the control device is configured to estimate a capacity of the battery within the range from the lower state-of-charge limit to the upper state-of-charge limit, and to calculate the capacity retention rate based on the estimated capacity.
